(19) United States
(12) Patent Application Publication
(10) Pub. No.: US 2013/0103246 A1
(43) Pub. Date: Apr. 25, 2013

(54) PARKING SYSTEM HAVING LONGITUDINAL AND TRANSVERSE GUIDANCE

(71) Applicant: Jochen Staack, Stuttgart (DE)

(72) Inventor: Jochen Staack, Stuttgart (DE)

(21) Appl. No.: 13/643,856

(22) PCT Filed: Apr. 19, 2011
(86) PCT No.: PCT/EP2011/056218

§ 371 Date: Jan. 7, 2013

(30) Foreign Application Priority Data
Apr. 28, 2010 (DE) 102010028330.4

(51) Int. Cl. B62D 15/02

(52) U.S. Cl. CPC B62D 15/0285
USPC 701/23

(57) ABSTRACT

A method in a parking system for supporting parking using a longitudinal guidance and a transverse guidance, and to such a parking system. The method includes: calculating a parking trajectory having at least one stopping point; detecting, independently of the driver's actions, that the calculated stopping point has been reached; and, in reaction to the detection, providing a signal for a steering change for a steering controller. On a time axis there consequently takes place an initiation of a steering change in time period before a time at which the driver changes gear and independently of it.

### FIELD OF THE INVENTION

The present invention relates to a method for supporting parking using a longitudinal guidance and a transverse guidance in a parking system, and such a parking system.

### BACKGROUND INFORMATION

A parking system (or a parking assistant) supports the driver during parking. For example, while passing a parking space, the latter is measured, and subsequently the driver is guided to the parking space by instructions. Guiding him into the parking space may take place in a passive form, in this instance, i.e., the driver has transmitted to him steering angle specifications as well driveaway commands and stopping commands. However, the parking assistant is also able to take over the parking actively, the driver only receiving driveaway and stopping specifications, and guidance being performed at least partially automatically by the system. In longitudinal guidance, the braking system and the driving system of the vehicle are actuated automatically. In transverse guidance, a steering controller is activated automatically by the parking assistant.

Whereas up to now, predominantly passive or partially automatic parking systems have been available, which either take over only a longitudinal guidance or only a transverse guidance, it may be expected that, in the future, parking systems having longitudinal guidance and transverse guidance will be available.

A parking maneuver is usually based on a calculated parking trajectory having at least one stopping point, at which a traction change (backwards->forwards, or forwards->backwards) and a steering change are required. Conventionally, for systems having pure transverse guidance, a steering change is triggered by a gear change by the driver, as is necessary in response to a directional change between two moves. The time sequence is illustrated in FIG. 1. Point 102 marks the reaching of a stopping point on time axis 100. After the driver has registered that the stopping point has been reached, at time 104 he makes a gear change. This is detected by the parking system, and in time period 106 an automatic steering change is carried out by the parking system. Consequently, at time 108 the vehicle is ready for the next move.

There exists a general need for holding the time required for a parking maneuver to as brief as possible. Thus, longitudinal as well as transverse maneuvers frequently represent interference for other traffic participants, by blocking one lane or by requiring swinging out onto another lane. Such interferences should be held to a minimum.

With respect to the retention time shown in FIG. 1 at a stopping point, it should be noted that many drivers become impatient in this connection, because during an assisted steering change the driver has nothing to do at this moment. Because of this, the retention time at the stopping point also becomes longer in subjective perception. This perception becomes reinforced correspondingly in response to parking maneuvers having a plurality of stopping points.

U.S. Pat. No. 6,059,063 describes an automatic steering system for a vehicle is described. The vehicle is stopped at a starting position. The driver operates a knob to select a certain parking mode. Then the control system controls a drive and steering, in order to set a specified standard steering angle. Then the vehicle is guided to a targeted parking position according to a specified standard parking maneuver.

### SUMMARY

It is one object of the present invention to provide a method in a parking system for supporting parking having longitudinal and transverse guidance, as well as providing such a system in which the retention time at a stopping point is minimized.

The present invention provides an example method for supporting a parking system using a longitudinal guidance and a transverse guidance, having the following steps: calculating a parking trajectory having at least one stopping point; detecting, independently of the driver's actions, that the calculated stopping point has been reached; and, in reaction to the detection, providing a signal for a steering change for a steering controller.

In accordance with the present invention, among other things, at least in a parking system having longitudinal guidance, the retention time at the stopping point is able to be minimized in a simple way. Such a system makes possible the detection that a calculated stopping point has been reached, based on sensor values that are recorded anyway, for instance, for planning the parking trajectory or for other driver assistance systems. The sensor data may relate to an environment of the vehicle, for example, a state of one or more wheels, of the braking system and/or of a drive of the vehicle.

The detection of a driver-initiated gear change thereby becomes just as superfluous as the detection of any other actions of the driver, such as an operation of the driver relating to the parking system, such as pressing a mechanical button or a soft key on a display, or an acoustical input by which a driver has to initiate a parking maneuver and/or a steering change in a usual system.

As may be seen in FIG. 1, the retention time at the stopping point is also made up in part of the reaction time which the driver needs in order to detect that the stopping point has been reached. In the present invention, since an action on the part of the driver does not have to be waited for, the retention time at the stopping point becomes shorter by this reaction time of the driver. All in all, an objectively as well as subjectively clear shortening of the time may be reached that the vehicle is retained at the stopping point.

Since the system does without the detection of driver actions, the parking system according to the present invention becomes simpler in comparison with conventional systems.

One parking trajectory is able to include a plurality of stopping points. After each recording of one of the plurality of stopping points, a signal for a steering change is able to be provided respectively. The advantages of the present invention become greater the more automatically guided moves a parking maneuver has, since the overall duration of the parking maneuver is reduced correspondingly.

The parking trajectory may include an automatically guided move directly before and/or directly after the stopping point. If, for example, the stopping point is located in the middle of a precalculated parking trajectory, the parking system is directly able to detect whether the precalculated stopping point has been reached, and may begin, directly after a steering change that has taken place, with the initiation of the next move, which minimizes the retention time at the stopping point once more.

The signal for a steering change may be provided, in particular, before a driver-initiated gear change or another action of the driver. If the driver carries out a gear change while the steering change is being executed, the retention time at the stopping point becomes shorter. In particular, the time subjectively spent at the stopping point also becomes shorter for the driver.

The signal for the steering change may refer to a steering change at standstill. This achieves a more robust, i.e., more reliable and simpler response of the parking system, on which the driver may also subjectively have more reliance.

Furthermore, in accordance with the present invention, a computer program for implementing one of the example methods described here is provided, if the computer program is run on a programmable computer device. This device may be a programmable microprocessor, for example, an application-specific, integrated circuit and/or a digital signal processor having an associated memory, which is installed in a vehicle. At least parts of a computer program may be stored in the form of following instructions on a machine-readable data carrier, such as a permanent or rewritable memory in or in association with a programmable computer device, or a removable CD-ROM, DVD or a USB stick. Additionally or alternatively the computer may also be provided for downloading on a programmable computer device, for instance, via a data network such as the Internet or a communications connection such as a telephone connection or a wireless connection.

Moreover, in accordance with the present invention, an example system is provided for supporting parking, having a longitudinal guidance and a transverse guidance, which has the following components: a component for calculating a parking trajectory having at least one stopping point; a component for detecting, independently of actions of the driver, that the calculated stopping point has been reached, and a component for providing, in reaction to the detection, a signal for a steering change for a steering controller. The system may be a parking system, for example, which is integrated into a driver-assistance system for a vehicle.

### BRIEF DESCRIPTION OF THE DRAWINGS

Additional aspects and advantages of the present invention will now be described in greater detail, with reference to the figures.

FIG. 1 shows a schematic illustration of a retention duration at a stopping point in a conventional parking system.

FIG. 2 shows functional components of a parking system according to an example embodiment of the present invention, in the form of a block diagram.

FIG. 3 shows a manner of operating the parking system of FIG. 2 in the form of a flow chart.

FIG. 4 shows a parking trajectory for further illustrating the manner of operating the parking system of FIG. 2, in a schematic form.

FIG. 5 shows an illustration of the retention time at a stopping point in the parking system of FIG. 2 according to the present invention.

### DETAILED DESCRIPTION OF EXAMPLE EMBODIMENTS

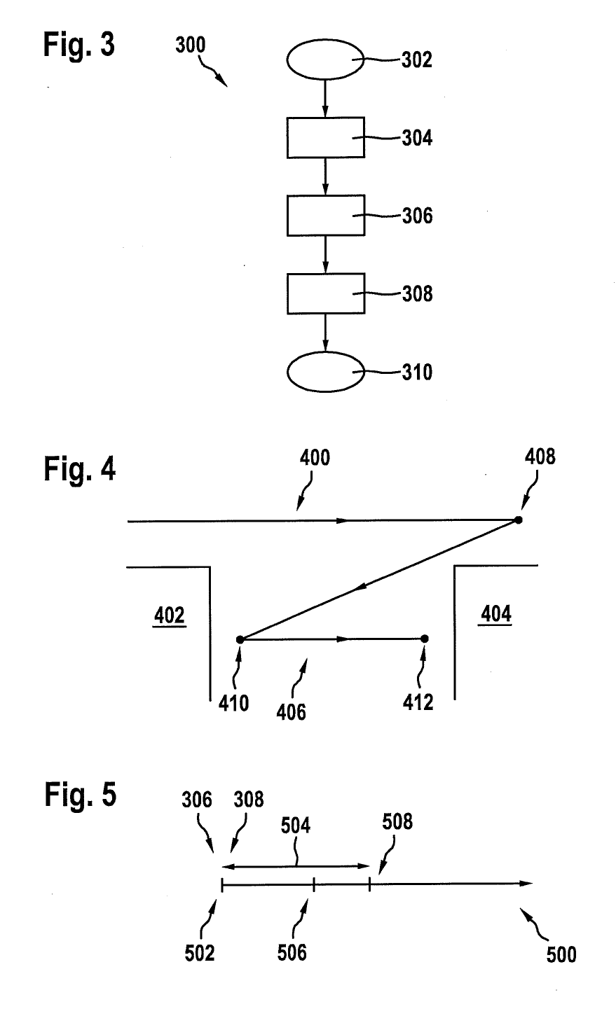

FIG. 2 shows an exemplified embodiment 200 of a parking system according to the present invention, having a calculation device 202, a detection device 204 and a providing device 206. A manner of operation of system 200 will now be described with reference to flow chart 300 shown in FIG. 3, a sketched exemplary parking trajectory 400 sketched in FIG. 4 and a sequence over time shown in FIG. 5. System 200 is basically used for supporting parking using a longitudinal guidance and a transverse guidance 302

According to the situation indicated in FIG. 4, between two objects 402 and 404, that border on a parking space, there is located a parking space 406, in which a vehicle, not shown any further, is parking along trajectory 400. Trajectory 400 includes stopping points 408, 410 and 412, at least at points 408 and 410 steering changes having to be made. As of point 408, at the latest, parking system 200 takes over the longitudinal guidance and the transverse guidance of the vehicle, so that the vehicle is guided automatically along moves 414 and 416. We shall now particularly go into the manner of operation of system 200 in the surroundings of stopping point and steering change point 410.

In step 304, calculation device 202 calculates parking trajectory 400 using at least the moves 414 and 416, as well as stopping points 408 (parking assistant 200 is able to be activated at this point, for example), steering change point 410 and stopping point 412. For this purpose, calculation device 202 may, for instance, resort to sensor data, such as of an ultrasonic sensor 208 indicated schematically in FIG. 2, which represent the environment of the vehicle.

After the activation of the parking system and the calculation of trajectory 400, the vehicle is guided into parking space 406 by parking system 200 along move 414 (for instance, backwards). In step 306, detection device 204 detects that calculated stopping point 410 has been reached. For this purpose, device 204 may resort, for instance, to wheel sensors 210, indicated schematically in FIG. 2, so as to detect a standstill of the vehicle, for example. Additional sensor data, for instance, from environmental sensor 208 and/or from sensors which detect, for example, the state of a braking system or a drive system, are also able to be processed in device 204.

When stopping point 410 is reached, the driver carries out at least one action, namely the operation of a gear lever 212, in order to undertake a gear change, such as to a forwards gear, at stopping point 410. Additional driver actions at stopping point 410 may include, for instance, according to conventional systems, operating a button, a key or a soft key on a display screen 214, for example, for controlling the parking system or other (driver assistance) systems present in the vehicle. Detection device 204, however, detects the reaching of stopping point 410 independently of such or any other actions of the driver, i.e. detecting driver actions no longer takes place.

In step 308, which follows directly step 306, providing device 206 is actuated by detection device 204, to emit a signal 216 to a steering controller 218 of the vehicle, so that steering controller 218 carries out a steering change of steering 220 in preparation for next move 416. Method 300 ends with step 310.

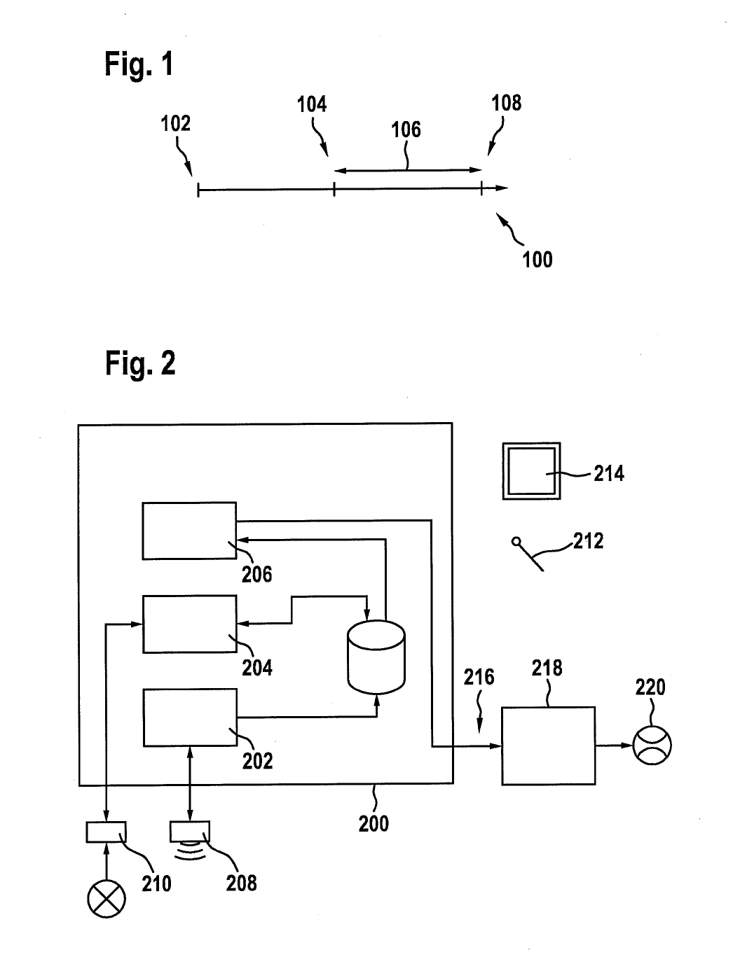

A time sequence during the retention time of the vehicle at stopping point 410 is shown in FIG. 5. For the sake of comparability, this representation has been selected to be analogous to that in FIG. 1. On a time axis 500, point 502 designates the time of reaching stopping point 410. At this point in time, step 306 is running (detecting the reaching of stopping point 410 and directly thereafter step 308 (signal emission to steering controller 218), so that change in steering 220 in time period 504 takes place immediately following the reaching of stopping point 502. During the change in steering in time period 504, the driver is able to carry out a gear change approximately at time 506, this gear change not having an effect on the way of operating of parking system 200 in steps 306 and 308. At time 508 the change in steering is finished and the vehicle is ready for next move 416.

As may be inferred directly from a comparison of FIG. 5 to FIG. 1, the parking maneuver is speeded up by parking system 200 working according to the present invention, since automatic parking system 200 no longer has to wait for the gear change by the driver, but initiates the steering change directly after the reaching of the stopping point. During the steering change, if the driver changes gear, the vehicle is ready for the next move directly after the ending of the change in steering. Since a parking system having longitudinal guidance already has a sensor system for monitoring the guidance along a parking trajectory, in this instance, the present invention makes possible the speeding up of a parking maneuver, in a surprisingly simple manner.

An additional advantage may be seen as the subjective shortening, to the driver, of the waiting time during the change in steering. He can change gear during the change in steering, and consequently does not have to wait idly for the end of the steering change process.

The advantages described above have a correspondingly greater effect in parking trajectories that have a plurality of stopping and/or steering change points. While referring again to the exemplary embodiment represented in FIGS. 2-5, we point out that parking system 200, developed according to the present invention, is also able to control a steering change at points 408 and 412, even when, as in this case, the delivering move does not take place automatically (408) or no further move takes place after stopping point 412 is reached. At point 408, parking system 200 is able to align the steering for move 414, as soon as after the activation of the parking system a parking trajectory has been calculated, without having to wait for the engaging of the reverse gear by the driver. Rather, the driver could take the beginning steering change of the wheels as an incentive to engage the reverse gear, so that in this case, too, a sequence as sketched in FIG. 5 would come about. The alignment of the wheels in stopping point 412, into a specified standard position may be regarded as a convenience feature of a parking assistant.

The present invention is not limited to the exemplary embodiments described above and the aspects emphasized therein; rather, a plurality of modifications are possible, that are within the scope of action of one skilled in the art, within the present field.

1-9. (canceled)

10. A method in a parking system for supporting parking using a longitudinal guidance and a transverse guidance, comprising:
calculating a parking trajectory having at least one stopping point;
detecting that the calculated stopping point has been reached, independently of driver actions; and
providing a signal for a steering change for a steering controller in response to the detection.

11. The method as recited in claim 10, wherein the parking trajectory includes an automatically guided move at least one of directly before and directly after the stopping point.

12. The method as recited in claim 10, wherein the parking trajectory includes a plurality of stopping points and after each detection of one of the plurality of stopping points, a corresponding signal is provided for the steering change.

13. The method as recited in claim 10, wherein the detecting takes place at least one of: i) independently of a driver-initiated gear change, and ii) independently of an operation by the driver that relates to the parking system.

14. The method as recited in claim 10, wherein the signal for a steering change is provided before a driver-initiated gear change.

15. The method as recited in claim 10, wherein the signal for the steering change relates to a steering change at a standstill.

16. A computer readable storage medium storing a program for a parking system for supporting parking using a longitudinal guidance and a transverse guidance, the program, when executed by a processor, causing the processor to perform the steps of:
calculating a parking trajectory having at least one stopping point;
detecting that the calculated stopping point has been reached, independently of driver actions; and
providing a signal for a steering change for a steering controller in response to the detection.

17. A machine-readable data carrier on which instructions for carrying out a method for a parking system for supporting parking using a longitudinal guidance and a transverse guidance, the instructions, when executed by a computer device, causing the computer device to perform the steps of:
calculating a parking trajectory having at least one stopping point;
detecting that the calculated stopping point has been reached, independently of driver actions; and
providing a signal for a steering change for a steering controller in response to the detection.

18. A system for supporting parking using a longitudinal guidance and a transverse guidance, comprising:
a component configured to calculate a parking trajectory having at least one stopping point;
a component configured to detect that the calculated stopping point has been reached, independently of driver actions; and
a component configured to provide a signal for a steering change for a steering controller, in response to the detection.
